(19) United States
(12) Patent Application Publication
(10) Pub. No.: US 2007/0288361 A1
(43) Pub. Date: Dec. 13, 2007

(54) Methods, systems, and products for adjusting loans after closing

(76) Inventor: Thomas M. Martignoni, Raleigh, NC (US)

Correspondence Address: SCOTT P. ZIMMERMAN, PLLC, PO BOX 3822, CARY, NC, 27519, US

(21) Appl. No.: 11/789,331

(22) Filed: Apr. 24, 2007

Related U.S. Application Data
(60) Provisional application No. 60/794,756, filed on Apr. 25, 2006.

(51) Int. Cl. G06Q 40/00

(52) U.S. Cl. 705/38

(57) ABSTRACT

Methods, systems, and products are disclosed for adjusting a loan. The loan is secured with collateral. A line of credit and/or a schedule of future payments is established, usually at closing. After closing of the loan, the line of credit and/or the schedule of future payments may be adjusted based on a value of the collateral and a balance of the loan.

### CROSS-REFERENCE TO RELATED APPLICATIONS

This application claims the benefit of U.S. Provisional Application 60/794,756, filed Apr. 25, 2006, entitled “Method to Readjust the Line Of Credit Of A Reverse Mortgage,” and incorporated herein by reference in its entirety.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND

The exemplary embodiments relate to mortgages and, more particularly, to lines of credit in reverse mortgages.

A reverse mortgage is a special type of loan used by older people to convert the equity in their homes into cash. With a reverse mortgage, the borrower retains the title to the home, and the home serves as collateral. With a reverse mortgage the borrower does not have to make monthly payments. The loan must be repaid when the last surviving borrower dies, sells the home, or, for most reverse mortgages, no longer lives in the home as a principal residence.

The following features are characteristic to most reverse mortgages.
Lenders generally charge origination fees and other fees for a reverse mortgage. Lenders also may charge servicing fees during the term of the mortgage. The lender generally sets these fees and costs. Other fees may be added to the loan.
The amount owed by the borrower on a reverse mortgage generally grows over time. Interest is charged on the outstanding balance and periodically added to the amount owed. That means the total debt (loan balance) increases over time as loan funds are advanced and interest accrues on the loan.
Reverse mortgages may have fixed or variable rates. Most have variable rates that are tied to a financial index and will likely change according to market conditions.
Reverse mortgages can use up all or some of the equity of the borrower's home, leaving fewer assets for the borrower and the heirs of the borrower. A “non-recourse” clause, found in most reverse mortgages, prevents either the borrower or the borrower's estate from owing more than the value of the home when the loan is repaid.

For most reverse mortgages the borrower can select how to receive the proceeds of the reverse mortgage. The borrower may receive the proceeds i) as a lump sum (at or immediately after the closing of the reverse mortgage), ii) as line of credit, iii) as monthly payments (lifelong as tenure or only for a certain time, as term), or iv) as a combination of any of these.

From the lender's perspective, the lender focuses on two major parameters. The first parameter is the potential profit in the mortgage. The potential profit depends on factors such as interest rate, cost of money, outstanding loan, duration and others. The second parameter is the potential risk in the mortgage. The risk factors involve the following three major categories: i) lender related, such as access to liquidity to fulfill contractual obligations; ii) borrower or collateral related risks, such as a default by the borrower or in the case of a collateralized non-recourse loan, the risk that the outstanding loan balance may exceed the value of the collateral at one time, or that the borrower doesn't protect the collateral as is the borrower's obligation; and iii) external factors such as governmental activities or acts of god. The major risk to the lender of a non-recourse reverse mortgage is the risk that the loan balance may exceed the value of the collateral. Another risk is the risk that the borrower fails to pay taxes or insurance and thus puts the collateral at risk.

The lender thus must cope with unknowns. The interest rate, for example, may impact the potential profit. The higher the interest rate, then the higher the potential profit. Charges and fees may also significantly contribute to the profit. The higher the principal (or balance) of the loan, the higher the total interest. The longer the duration of the loan, then the higher the potential profit. Interest rate, charges and fees, however, are subject to governmental regulations and market forces, so there may be an upper limit on possible interest rates. Most reverse mortgages accrue with an adjustable interest rate that is somehow tied to a financial index. For the lender it is preferable that the index reflects the cost of money. Typical financial indices used are the 1-year US Treasury Constant Maturity rate or the LIBOR. A reverse mortgage usually lasts until the last borrower passes away or no longer lives in the home or sells the home. Most reverse mortgages leave it to the borrower to decide on the time and the amount of cash advances—within certain limits and following certain conditions. The lender thus scopes with many unknowns, and generally neither the duration of a reverse mortgage nor the loan balance can be predicted.

In the year 2005 over 90% of the reverse mortgages closed were HECM (Home Equity Conversion Mortgage) reverse mortgages. HECM are federally insured reverse mortgages that are supervised by HUD. In the case of the HECM loan, a federal insurance, administered by HUD, covers the potentially highest risk the lender is exposed to (the risk that the loan balance may exceed the value of the collateral). Whether it is the government, or a private institution, somebody has to cover the risks.

The current reverse mortgages on the market have some significant drawbacks that actually exacerbate the risks instead of mitigating them. There is sometimes a disconnect between collateral and loan balance. During the origination process of a reverse mortgage the value of the collateral (e.g., the home), is defined through an appraisal. The principal limit (the maximum of the loan principal) is calculated as a function of different factors such as the value of the collateral (home), the expected interest rate, the number and age of the borrower(s), the location and type of the home and other factors. To maximize the profit potential, the lender would like the principal limit to be as high as possible in order to be able to lend the highest amount possible. At any time the outstanding loan balance accrues with an adjustable rate, which is based on a benchmark index. The collateral (the home) however does not accrue based on the same index. Generally, real estate values do not follow the same indices as financial instruments do. Any particular real estate property may also fail to follow a particular wider index, as local situations as well as modifications to the home may affect its value.

It is, therefore, that the balance of the loan accrues with a different rate than the value of the underlying collateral. This bears the risk to the lender that at one time the collateral does not cover the outstanding balance anymore. If a non-recourse loan is paid off when the value of the collateral is less than the balance of the outstanding loan, the lender loses the difference. In the case of the HECM loan, this risk is covered by government backed insurance. But even with an insurance, the cost for the borrower is significant, as the borrower pays an insurance premium. A higher cost for the borrower makes the loan less attractive, as a consequence the lender loses business.

Lenders cannot always protect themselves from disconnected collateral and loan balance. Most popular reverse mortgages allow for a line of credit, and with most reverse mortgage programs this line of credit grows over time. In the case of HECM the growth rate of the line of credit is the same as the interest rate used to calculate the accrued balance of the loan. This means, that independent of when a borrower draws all the cash in the line of credit, as long as the borrower draws all the cash (and has no tenure or term set up) the accrued balance (after such draw) is the same, allowing for some minor differences from particular fees. In other reverse mortgage programs the line of credit grows with a fixed percentage rate, independent of what the applied rate to the loan balance is. Generally, it does make sense that the line of credit for a reverse mortgage grows with time. As an example, suppose a borrower has a line of credit of $100,000 today and doesn't touch this line of credit for 30 years. $100,000 today is not the same as $100,000 in 30 years, thus it is intuitively understandable, that a line of credit changes over time, most likely it grows.

The question is, how much should it grow? The position of the HECM program is that it should grow exactly as much as the interest applied to the borrower's loan balance. Whenever the line of credit grows according to a predetermined formula or based on a financial index, there is a very high risk, that the line of credit grows differently than the collateral. Hence if the borrower draws from the line of credit there is a risk, that at one time the collateral may not cover the whole value of the outstanding loan balance including accrued interest. If at this time the borrower draws the full line of credit, the outstanding balance will then be higher than the value of the collateral, thus the lender loses the difference—or there is some insurance or other mechanism that protects the lender.

FIG. 1 is a chart illustrating the conventional HECM-style reverse mortgage. FIG. 1 illustrates a simplified HECM-style reverse mortgage, based on the following assumptions.

Initial property value: $400,000 (value of the collateral at closing of the loan)

Initial principal limit: $200,000

Interest rate: 7% (annual rate over the whole course of the loan)

Line of credit growth rate: 7% (annual rate over the whole course of the loan)

Property value growth rate: 4% (annual rate at which the value of the collateral grows)

Liquidation cost of property: 7% (estimated cost to liquidate the collateral (the home))

Initial fees: $10,000 (assuming that the fees are financed)

Annual fees: $360 (fees to service the loan)

Initial draw: $90,000 (lump sum paid to the borrower at closing)

Other draws: $0

X-Axis: years (0 meaning year of closing)

Y-Axis: $

FIG. 1 does not show any set-aside—for simplification. The fees are summarized, and the interest is applied on an annual basis at a fixed rate. In reality any other accrual period may be chosen and the rate may be based on an index. There is no term or tenure and markup for insurance included in the interest or the fees.

The following conventions apply to FIG. 1.
Accumulated fees are the fees that have accumulated over the years, including the closing fees. They include the initial fees, which are the fees that occur with the closing of the reverse mortgage and the fees after the closing, mostly servicing fees. The fees are simply accumulated and not accrued (interest and accrual are separately shown). It is assumed that the fees are financed with the loan. Any fees not financed through the loan are not shown in this chart.
In a reverse mortgage, often there is not a clear difference between the loan and the fees. This is because fees are usually financed though the loan. Thus what from the lender's perspective is the Loan; from the borrower's perspective is the loan plus fees.
In this context, the term “Loan+Fees” means the accumulated fees plus the accumulated cash or cash-equivalent advances to the borrower or to an assignee. The line “Loan+Fees” does not include any interest—just the accumulated loan advances and fees, thus it does not represent the loan balance—except in the case where no interest has accrued.
“Loan+Fees” plus accrued interest make the loan balance.
“Loan Balance+LOC” (or “line of credit”)—the difference between the line “Loan Balance” and the line “Loan Balance+LOC” is the line of credit. In other words: the “Loan Balance+LOC” is created by adding the line of credit on top of the loan balance. If at any time the borrower draws all cash from the line of credit, the loan balance will jump to the “Loan Balance+LOC.” In the case of the HECM the new “Loan Balance” after such draw will follow the line “Loan Balance+LOC,” allowing for some minor adjustments. This is not necessarily the case for other reverse mortgages. In a simplified view “Loan Balance+LOC” equals the principal limit.
Adjusted Value of Collateral—if at any time the reverse mortgage is terminated (paid off), the borrower will have to pay to the lender the amount of the loan balance, which is the sum of the accumulated fees, the accumulated loan and accrued interest. However in a non-recourse situation the lender will not be able to recover more than the value of the collateral (at the time of paying off the loan). In addition there are usually liquidation costs involved when liquidating the collateral. This is taken into consideration in all the charts by not plotting the effective value of the collateral, but the adjusted value of the collateral (the home). The adjusted value is the value of the collateral at a given time based on the initial value (at closing of the loan) and the assumed property value growth rate, adjusted for the liquidation cost of the property.

As FIG. 1 illustrates, at closing (year 0) the loan balance is $100,000. This consists of the initial draw plus the initial fees. (Typically with a reverse mortgage, closing fees are financed through the loan.) As there is no tenure or term set up and as there is no set aside, the line of credit is the difference between the loan balance and the principal limit, which is $100,000 in the year 0. In this example no additional draw from the line of credit is made over the years, thus the line that indicates “loan+fees” is flat. However interest accrues over time so that the loan balance grows. As long as at the time of the pay-off (termination) of the loan the loan balance is less than the adjusted value of the collateral, the lender will receive the full amount of the loan balance. If however at that time the loan balance exceeds the adjusted value of the collateral, the lender is likely to suffer a write-off. In the chart shown in FIG. 1, the lender is covered over the full range of 31 years.

FIG. 2 is a chart illustrating another example for the conventional HECM-style reverse mortgage. This chart is based on exactly the same assumptions as FIG. 1, with the exception that in the year 25 the borrower draws the full line of credit ($507,237 in the year 25). Note how this is calculated. The interest accruals of all calculations in this document are made on an annual basis. At the end of year 24 the line of credit has accrued to $100,000*(1+0.07)̂24=$507,237. This is then the line of credit that is available in the following year, the year 25. In this example the loan balance exceeds the adjusted value of the collateral in the year 25 and thereafter. If paid off in the year 31 this would result in a write-off of $413,535 for the lender. This on a loan starting with a property value of $400,000 and a loan of $90,000 plus financed fees of $10,000.

FIG. 3 is a chart illustrating yet another example for the conventional HECM-style reverse mortgage. FIG. 3 is based on the same assumptions as is FIG. 1, except for the property value growth, which is assumed at 2% instead of 4% (as in FIGS. 1 and 2). In FIG. 3 the Property Value growth is 2% (annual rate at what the value of the collateral grows). In this case the adjusted collateral still covers the loan balance for several years. Nevertheless, in the year 31 there is a write-off of $166,527. But the biggest risk to the lender in this example is the fact that the line of credit grows disconnected from the underlying value of the collateral. In fact the line of credit in FIG. 3 grows exactly the same way as in FIG. 1, although the collateral grows much slower. In the year 31 the line of credit has grown to $814,511 (this on top of the loan balance of $853,830), while the adjusted value of the collateral is only $687,303. If in the year 31 the borrower draws the full line of credit and then pays off the loan with the collateral, the lender would suffer a write-off of $981,038. This shows the significant risk to the lender when the line of credit can grow disconnected from the value of the underlying collateral.

What is needed, then, are systems, methods, and products for reducing the risk of when the line of credit grows independent of the value of the underlying collateral.

### SUMMARY

The aforementioned risks, and other risks, are reduced, according to the exemplary embodiments, by methods, systems, and products that adjust the line of credit of reverse mortgages, collateralized, non-recourse loans, or other instruments. Only at the time of closing is the amount of the line of credit in line with the value of the collateral. The longer the loan runs, the more likely it is that the amount of the line of credit and the value of the underlying collateral become disassociated. Exemplary embodiments of this invention, however, permit readjusting the line of credit in light of the value of the collateral. The calculation of key parameters of the reverse mortgage at closing can be similar to the way a HECM reverse mortgage is calculated. Other actuarial tables or other numbers may be used. Also some set-asides may be added (for instance for taxes or insurances) others may be omitted. Alternatively completely different methods of calculating the reverse mortgage at closing may be used, or a modified version of the exemplary embodiments as shown later.

Exemplary embodiments thus calculate and/or track the reverse mortgage after closing. Exemplary embodiments may or may not alter the way an outstanding loan balance accrues. The outstanding loan balance accrues based on an interest rate that is derived from an index such as a LIBOR rate, a treasury spot index, an US treasury constant maturity rate or another index or a fixed or otherwise predetermined rate. Preferably but not necessarily the index is related to the rate at which the lender can borrow. Exemplary embodiments adjust the line of credit based on the balance of the loan, the estimated value of the collateral at the time of the adjustment of the line of credit, interest rates or expected interest rates, the life expectancy of the borrower or borrowers, possible set-asides, fees and other variables as further described.

Exemplary embodiments describe method, systems, and computer program products for adjusting a loan. The loan is secured with a collateral. A line of credit and/or a schedule of future payments is established, usually at closing. After closing of the loan, the line of credit and/or the schedule of future payments may be adjusted based on a value of the collateral and a balance of the loan at a time of adjustment.

### DESCRIPTION OF THE DRAWINGS

These and other features, aspects, and advantages of the embodiments are better understood when the following Detailed Description is read with reference to the accompanying drawings, wherein:

FIGS. 1-3 are charts illustrating different examples for conventional HECM-style reverse mortgages;

FIG. 4 is a schematic illustrating an operating environment, according to exemplary embodiments;

FIG. 5 is a flowchart illustrating a method of readjustment, according to exemplary embodiments;

FIG. 6 is a chart illustrating a reverse mortgage calculated using the method of FIG. 5, according to more exemplary embodiments;

FIG. 7 is a chart illustrating another reverse mortgage calculated using the method of FIG. 5, according to even more exemplary embodiments; and

FIG. 8 is a chart illustrating still another reverse mortgage calculated using the method of FIG. 5, according to more exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

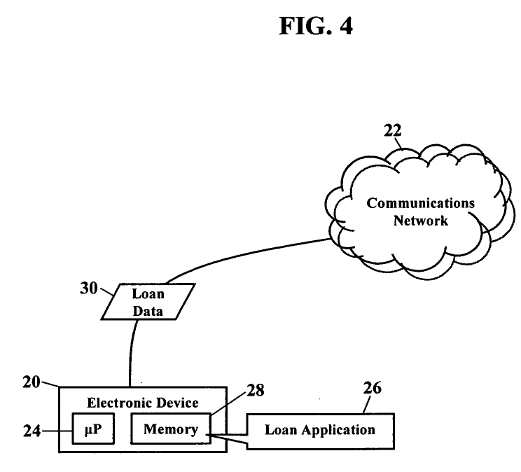

FIG. 4 is a schematic illustrating an environment in which exemplary embodiments may be implemented. While exemplary embodiments may be applied to any manual or paper environment, here exemplary embodiments are applied to a network environment. An electronic device 20 communicates with a communications network 22. The electronic device 20 comprises a processor 24 (e.g., “μP”), application specific integrated circuit (ASIC) or a network of computers or processors, or other similar device that executes a computation 26 stored in memory 28. Although the electronic device 20 is generically shown, the electronic device 20, as will be later explained, may be a computer, server, or any other device. Whatever the electronic device 20, the electronic device 20 may receive loan data 30 from the communications network 22. The loan data 30 describes one or more reverse mortgages and/or collateralized, non-recourse loans. According to exemplary embodiments, the computation 26 may comprise processor-executable instructions that address the way a line of credit in any of these ongoing (active) reverse mortgages or collateralized, non-recourse loans is adjusted over time.

Once a reverse mortgage is closed and active, the reverse mortgage can be divided into three (3) categories:

1. The Loan Balance
The loan balance stands for the history of the reverse mortgage. It is the total of the fees financed with the reverse mortgage, the cash paid to the borrower or third parties (insurances, authorities, payoffs and others), accrued interest and other positions. It is the amount the borrower owes to the lender.

2. Non-Discretionary Future Benefits
Non-discretionary future benefits are future cash or non-cash advances to the borrower or third parties that the lender has committed to fulfill without condition or under some conditions. Non-discretionary future benefits may include direct cash advances to the borrower such as term payments, tenure payments, annuities or other future payments. Also indirect benefits such as a commitment by the lender to cover property taxes or property insurance premiums, health insurance premiums or other insurance premiums or fees are non-discretionary future benefits. This category also includes non-monetary future services by the lender or a subcontractor such as servicing of the loan or a commitment to cover other services such as health care, long-term care or other services. A present monetary value can be assigned to such non-monetary future services.
These are predefined benefits that happen on certain events in the future, such as each beginning of a month, the date when an insurance premium becomes due. The amount of each such advance may be fixed at the closing of the loan (such as for term or tenure advances) or it may be subject to a third party decision (such as for insurance premiums).

3. Discretionary Future Benefits
Discretionary future benefits are benefits to the borrower in the form of future cash or non-cash advances by the lender, that are at the borrower's discretion. Discretionary future benefits mainly consist of the line of credit. Up to a defined limit, the borrower can draw cash from the line of credit at the borrower's own discretion. Subject to possible additional restrictions, the time and amount of any cash or non-cash advances by the lender is basically at the discretion of the borrower.

At any given time, the current loan balance, the non-discretionary future benefits and the discretionary future benefits are factors that impact the future loan balance. Time, rates, growth rates and other factors also impact the future loan balance.

Most of the factors that control the future loan balance are not in control of the lender, although it would be in the lender's interest to exercise such control. The borrower and the lender can influence the way the discretionary future benefits are paid out, or in other words, the pattern and amount of cash withdrawals by the borrower against the line of credit. The major control by the lender on this discretionary future benefits is the limit applied to the line of credit. It is then the borrower's decision on when and how much of this line of credit the borrower draws. By exercising control over discretionary future benefits, the lender can influence the amount of the future loan balance. An arbitrary control and change of the line of credit by the lender however is neither practical nor is it acceptable to the borrower. And in most cases it is not desirable for the lender either.

To the lender the main objective for limiting the line of credit is to limit the risk that the loan balance exceeds the adjusted value of the collateral. Exemplary embodiments address this and other objectives. Instead of defining the growth-rate for the line of credit ahead of time (for example during the origination process), no intrinsic growth rate is assigned to the line of credit, or only a very minor growth rate that on average is lower than the anticipated appreciation rate of the collateral. This growth rate may be less than the anticipated appreciation rate by any amount, and the growth rate may even be a minimal value or zero or possibly a negative value.

The line of credit may be readjusted. The line of credit, for example, may be readjusted at one or more defined intervals, at the request of the borrower, at the request of the lender, and/or when certain trigger factors are reached (such as when the line of credit falls below a certain amount, when one borrower passes away, and/or other trigger factors). Conditions under which the line of credit is readjusted may be agreed upon beforehand between the lender and the borrower. The lender may also offer such readjustment to the borrower at lender's discretion.

Current reverse mortgage products do not have a method to readjust the line of credit, the tenure or term parameter or other limits. These current reverse mortgage products are usually fixed or tied to an index. The only way such a readjustment can be done is through a new loan or a process called refinancing, which is another expression for making a new loan. Refinancing is completely at the borrower's discretion; it is a much more complicated process and usually requires a new qualification of the borrower. Also a refinance process is usually quite costly. In a refinance process or when the reverse mortgage is paid off and the borrower takes a new reverse mortgage, the borrower is free to switch to another lender. Thus the original lender may lose the customer or may be pushed to grant better terms to the customer.

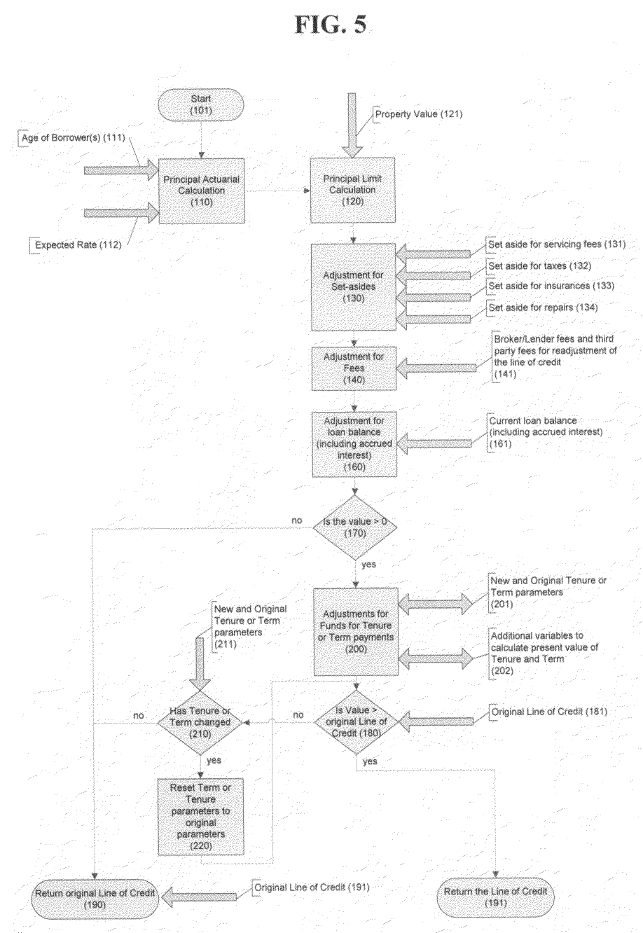

FIG. 5 is a flowchart illustrating a method of readjustment, according to exemplary embodiments. This is just a sample. Preferably, although this is not required, the flowchart may be implemented in a computer program or programs for faster execution. Also the computer program or programs may have additional validation of the data entered.

The method starts at block 101. The principal actuarial calculation block (110) provides an actuarial calculation based on the age and number of the borrower(s) (111) and the expected interest rate (112). Some actuarial calculations may demand different or additional input parameter such as gender, location where the borrower(s) live, health factors, genetic factors and other factors.

An actuarial calculation is a widely used procedure to estimate annuities and other financial products that are calculated based on life expectancy or other key statistics related to people. A modified actuarial calculation could be applied here that would not be based on the life expectancy, but based on the expectation of how long the borrower or borrowers will live in the home that serves as collateral. Actuarial calculations often involve mathematical calculations, statistics and tables. A sample calculation of block (110) follows later. Actuarial calculations are generally used to calculate reverse mortgages during the origination process.

The output of block (110) can be a single factor, a table, formula or procedure. The principal limit calculation block (120) uses as input variable the property value (121) and the output of block (110). The property value is the current, estimated or assumed value of the collateral. The estimation of the value can come from different sources. It can be based on a recent appraisal, from a database, a website, a web service (for instance an Automated Valuation Service or “AVS”), a public or private archive, tax records, an estimate or another source. As some sources are more reliable, more up-to-date or more accurate, the type of source itself may be used as a variable in the principal limit calculation. The property value may be adjusted for some factors. The simplest form for a principal limit calculation is a simple multiplication where the property value (121) is simply multiplied with a single factor from block (110). More complicated calculations, however, may account for the location of the property. The location of the property may even apply a cap on the maximum value of the property or apply a progressive formula or tables. The property value may be multiplied by a localization factor that is at least partially determined by postal ZIP codes, county codes or other localization factors, based on a formula or lookup table. The output of block (120) is a value. It could be a factor, or a set of values or a method or a formula. In the simplest form it is just a value representing a dollar or currency amount.

Block (130) adjusts the output value of block (120) for set asides. An adjustment may be a simple subtraction or a more complicated method that also evaluates the probabilities that a particular set aside might not cover the cash flow it is required to cover. A set aside is an amount that is reserved for a particular purpose. Usually a set aside is the present value of expected future cash flow or the present value of future services. The cash flow or costs that are covered by the set aside are usually paid by the lender to a third party or they are costs that occur at the lender for lender services. Typical set asides are the set aside for servicing fees (131) which is the present value of the expected future fees that cover the servicing of the loan, the set aside for taxes (132) which is the present value of expected future taxes that the lender has agreed to pay directly or to release later, the set aside for insurances (133) which is the present value of expected insurance premiums such as home owner insurance, flood insurance, and other insurances that the lender has agreed to pay directly or release later and the set aside for repairs (134) which is a set aside that covers expected repairs. Each set aside has its own rule how it is calculated and whether it has built in reserves. Possibly also set asides for future line of credit adjustments may be made.

Block (140) adjusts the output of block (130) for fees (141) that are incurred by the line of credit adjustment method. These fees may include appraisal fees, pest inspection fees, flood certification fees, title verification fees and other fees. Adjustments in the blocks 130, 140, 160, 200 may be simple subtractions, or they may take more complex forms of calculations.

Block (160) adjusts the output of block (140) for the current loan balance including accrued interest (161). If the output value of block (160) is not higher than zero, then the line of credit cannot be adjusted. This decision is made by the decision block (170). If the answer of decision block (170) is yes or the decision block 170 is omitted, then the method moves to block (200).

A term or a tenure is an obligation by the lender to make periodic payments to a borrower for an amount of periods, starting at a certain date. The amount of periods can be fixed or it can depend on certain events including but not limited an expiration of time. In the context of this disclosure “term or tenure parameters” means the amount of the periodic payments, the period and the start or the amount of periods (whether fixed or dependent on certain events) of such payments or a combination thereof.

Based on the new tenure or term parameters (201) and additional variables (202), block (200) makes a present value calculation of the tenure or term. If the parameters have not changed from the original parameters (meaning that the borrower wants to keep the same tenure or term) the original parameters will be used instead of the new parameters. A present value calculation for a term or tenure is a standard operation. Input value from block (170) is then adjusted for the present value of the term or tenure at the time the method is executed or the initial present value at the closing of the reverse mortgage.

The output of block (200) is the suggested new line of credit. In the decision block (180) this suggested new line of credit is compared with the original line of credit (181). Only if the suggested new line of credit is higher than the original line of credit, the method returns the new line of credit (191). Else the decision block (210) verifies if the new term or tenure parameters have changed (as compared to the original parameters) and if yes, redirects the method to reset the term or tenure parameters to the original parameters in block (220) before returning the original line of credit (190). If the answer of decision block (210) is no, then the original line of credit (190) is returned directly.

The original line of credit is the line of credit that is current for the particular reverse mortgage at the time before the line of credit adjustment method is started. The original tenure or term parameters are the parameters that are current for the particular reverse mortgage at the time before the line of credit adjustment method is started.

The line of credit adjustment method can also be applied when the borrower demands a change of the tenure or term parameter, or when, due to predefined situation (such as reaching a certain time or reaching a certain value or other), a change in the parameters is required, to accommodate for a change in the situation of the loan or when one borrower passes away.

Block (200) shows bi-directional interfaces. In the discussed embodiment the interfaces (201) and (202) are used in a one-directional way. Those of ordinary skill in the art will understand how to extend block (200) to make an iteration or a straight calculation in order to accommodate the new tenure or term parameters so that a particular output value of block (200) is achieved. As a variation of the exemplary embodiments the adjustment may be performed to other discretionary or non-discretionary benefits than the line of credit.

With some changes the line of credit adjustment method may accommodate for slightly different objectives or priorities. In the embodiment according to FIG. 5 the line of credit adjustment method may not return a line of credit lower than the original line of credit. Instead of using a simple decision process (block (180)) which decides if the value coming from block (200) is greater than the original line of credit, another predefined formula might be applied. Such formula may be as simple as returning the higher of the value coming from block (200) without comparing it to the original line of credit and zero. More sophisticated formulas, where the value coming from block (200) is further processed, and additional parameters are taken into account can add more flexibility. Modifying block (180) may require adjustments to other blocks, namely to block (210) and block (220).

By changing some sequencing of the blocks, omitting some blocks or separating blocks, or even splitting blocks and rearranging the sequence of the split blocks, different objectives may be accommodated. With a slight modification the line of credit adjustment method can be altered so that it adjusts the tenure or term—basically resulting in adjustable term or tenure payments based on the value of the collateral, the home.

### Costs and “Dry Runs”

An adjustment of the line of credit method requires some information such as the property value, expected insurance premiums, credit reports and others. Information, whether it is available internally or has to be retrieved from outside the organization may have a cost such as the cost for an appraisal, credit report, title verification, death verification and the cost for other internal or external services. Some of these external services, such as an appraisal, may take some time and need to be performed asynchronously. Other information services, such as a request for an insurance premium or an automated valuation service, may be immediately available from an automated service, such as a web service. The factor time usually also means some cost.

It may be assumed that the more accurate and reliable the information the more expensive it is. Normally one would be willing to pay more for more accurate and reliable information. Thus, depending on the required accuracy and reliability of the outcome, the cost of an adjustment of the line of credit may be different. This may be covered by the lender, a third party or the borrower, or shared. The part covered by the borrower shows up in a fee, such as the fee (141)

It may therefore make sense to sometimes run the adjustment of the line of credit method based on less accurate and less reliable information, being aware and accepting that the result is only an approximation. This is called a “dry run”. By varying the accuracy and reliability of the information supplied into the dry run, the reliability and accuracy of the output may be varied.

As an example: an adjustment of the line of credit may require a current appraisal of the property, which requires time and is costly. However an online service (such as an Automated Valuation Service—at the time of filing this application, www.reavs.com or www.zillow.com offered such services) may provide an instant and comparatively cheap estimate of the current property value. Alternatively an estimate of the property value based on expected appreciation for the location may be used. Locations having higher expected rates of appreciation will yield greater expected property values over time.

It may make sense to perform a dry run prior to an adjustment of the line of credit. This allows one to evaluate if an adjustment will bring some benefit to the borrower before occurring expenses. Also dry runs may be executed by the lender or borrower or a third party at regular, periodic, or arbitrary intervals or based on some trigger values. If the “dry run” indicates a significant chance for a substantial change of the limit of the line of credit or the term or tenure, a full run of the line of credit adjustment method may be executed or suggested. Thus dry runs may be used for marketing purpose, as they allow the lender to send an estimate to the borrower, promoting additional benefits to the borrower based on an adjustment of the line of credit. This can be performed at the discretion of the marketing department or as part of the monthly statements.

The exemplary embodiments may be used as part of the origination calculations during the origination process. Actually it may be advantageous that some blocks of the line of credit adjustment method are also used for some origination calculations, all blocks that need to perform the same calculations, depending on the design should be shared. An example of such a block is block (110), which is the principal actuarial calculation.

A simplified sample example analysis of the line of credit adjustment method is based on the following two tables used in block (110). Many actuary tables and calculations are more sophisticated than just looking up these two tables.

TABLE 1
IRS non-sex based life expectancy table (2002)

| | Life |
|---|---|
| Age | Expectancy |
| 60 | 25.2 |
| 61 | 24.4 |
| 62 | 23.5 |
| 63 | 22.7 |
| 64 | 21.8 |
| 65 | 21 |
| 66 | 20.2 |
| 67 | 19.4 |
| 68 | 18.6 |
| 69 | 17.8 |
| 70 | 17 |
| 71 | 16.3 |
| 72 | 15.5 |
| 73 | 14.8 |
| 74 | 14.1 |
| 75 | 13.4 |
| 76 | 12.7 |
| 77 | 12.1 |
| 78 | 11.4 |
| 79 | 10.8 |
| 80 | 10.2 |
| 81 | 9.7 |
| 82 | 9.1 |
| 83 | 8.6 |
| 84 | 8.1 |
| 85 | 7.6 |
| 86 | 7.1 |
| 87 | 6.7 |
| 88 | 6.3 |
| 89 | 5.9 |
| 90 | 5.5 |
| 91 | 5.2 |
| 92 | 4.9 |
| 93 | 4.6 |
| 94 | 4.3 |
| 95 | 4.1 |
| 96 | 3.8 |
| 97 | 3.6 |
| 98 | 3.4 |
| 99 | 3.1 |
| 100 | 2.9 |
| 101 | 2.7 |
| 102 | 2.5 |
| 103 | 2.3 |
| 104 | 2.1 |
| 105 | 1.9 |
| 106 | 1.7 |
| 107 | 1.5 |
| 108 | 1.4 |
| 109 | 1.2 |
| 110 | 1.1 |
| 111 | 1 |

TABLE 2
Principal Limit Factor based on Life Expectancy

| | Principal |
|---|---|
| Life | Limit |
| Expectancy | Factor |
| 29 | 0.014 |
| 28 | 0.038 |
| 27 | 0.063 |
| 26 | 0.088 |
| 25 | 0.113 |
| 24 | 0.138 |
| 23 | 0.163 |
| 22 | 0.188 |
| 21 | 0.214 |
| 20 | 0.24 |
| 19 | 0.266 |
| 18 | 0.292 |
| 17 | 0.319 |
| 16 | 0.346 |
| 15 | 0.373 |
| 14 | 0.4 |
| 13 | 0.427 |
| 12 | 0.454 |
| 11 | 0.482 |
| 10 | 0.51 |
| 9 | 0.538 |
| 8 | 0.566 |
| 7 | 0.595 |
| 6 | 0.624 |
| 5 | 0.653 |
| 4 | 0.682 |
| 3 | 0.711 |
| 2 | 0.74 |
| 1 | 0.77 |

For the following sample calculations we assume very simplified blocks. In block (110) the interest rate is disregarded. Instead a table is used to first look up the life expectancy of a borrower and then based on the life expectancy look up a principal limit factor, which will then be forwarded to block (120), where a simple multiplication takes place—the property value is simply multiplied with the principal limit factor to calculate the principal limit.

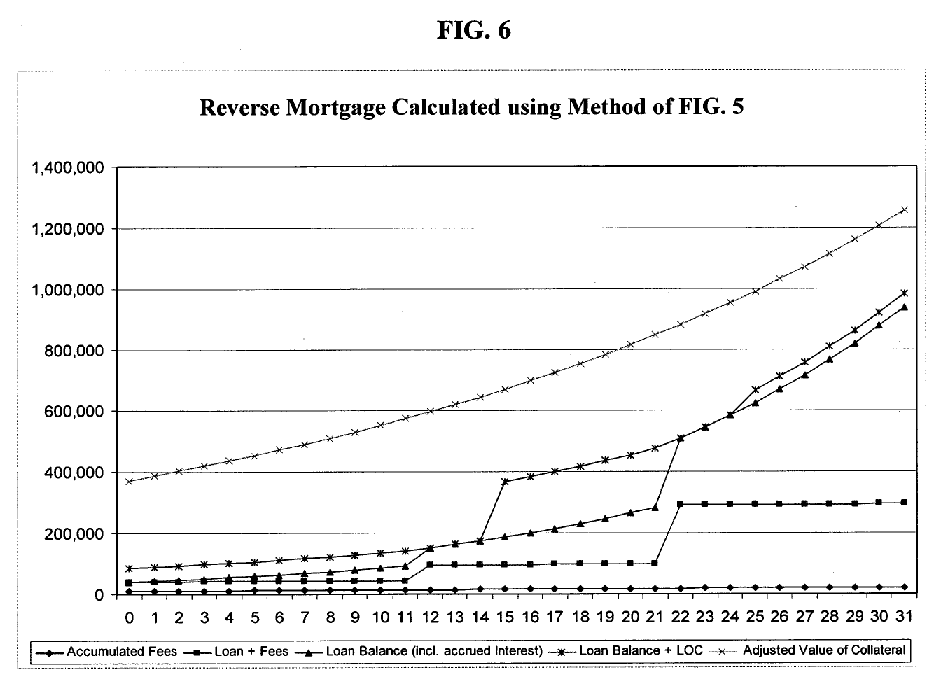

FIG. 6 is a chart illustrating a reverse mortgage calculated using the method of FIG. 5, according to more exemplary embodiments. FIG. 6 illustrates the course of a reverse mortgage with adjustments of the line of credit based on the property value.
Initial property value: $400,000 (value of the collateral at closing of the loan)
Interest rate: 7% (annual rate over the whole course of the loan)
Line of credit growth: 1% (annual rate over the whole course of the loan) (however the line of credit can be adjusted with the line of credit adjustment method)
Property value growth: 4% (annual rate at what the value of the collateral grows)
Liquidation cost property 7% (estimated cost to liquidate the collateral (property))
Initial fees: $10,000 (assuming that the fees are financed)
Annual fees: $360 (fees to service the loan)
About the borrower: Single borrower, age 65 at closing.
Initial draw: $30,000 (lump sum paid to the borrower at closing)
Other draws: $0
X-Axis: years (duration of the reverse mortgage, 0 meaning year of closing)
Y-Axis: $
Major simplifications:
   the diagram does not show any set-aside—for simplification
   Fees are summarized
   Interest is applied on an annual basis, the rate is fixed. In reality any other accrual period may be chosen and the rate may be based on an index or otherwise change.
   No term or tenure
   Markup for insurance is included in the interest or the fees

At closing, the age of the borrower is 65, resulting in a life expectancy of 21 years (see Table 1). From Table 2 the principal limit factor is 0.214. This is multiplied with the initial property value of $400,000, resulting in a principal limit (output of block (120)) of $85,600. After adjusting for the initial draw (lump sum) and the initial fees the line of credit is $45,600.

In year 12, the borrower draws all the line of credit, $50,874, which is $45,600*(1+0.01)̂11.

In year 15, the age of the borrower is now 80, resulting in a life expectancy of 10 years (rounded from Table 1), which gives a principal limit factor of 0.51 (Table 2). This is multiplied with the property value which is $720,377 in this year based on the above assumptions and run through the rest of the line of credit adjustment method, block (130) and forward, results in a line of credit of $180,665.

In year 22, the borrower draws all the line of credit. The line of credit has grown from the year 15 to the year 21, six years to $191,780=$180,665*(1+0.01)̂6.

In year 25, the age of the borrower is now 90, resulting in a life expectancy of 5.5 years (see Table 1) (rounded 6 years), which gives a principal limit factor of 0.624 (see Table 2). This is multiplied with the property value which is now $1,066,335 and run through the rest of the line of credit adjustment method, block (130) and forward, results in a line of credit of $41,366.

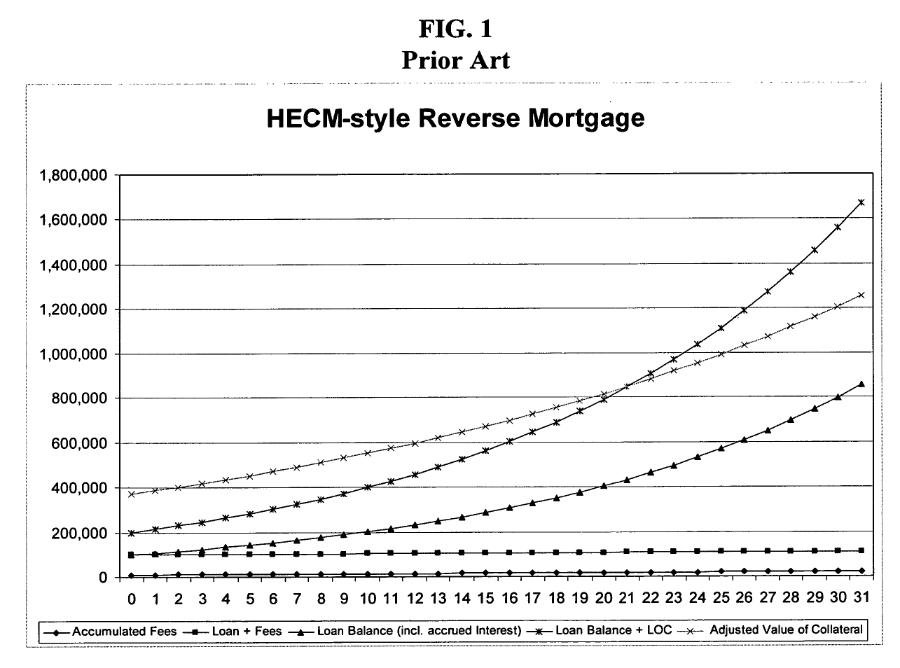

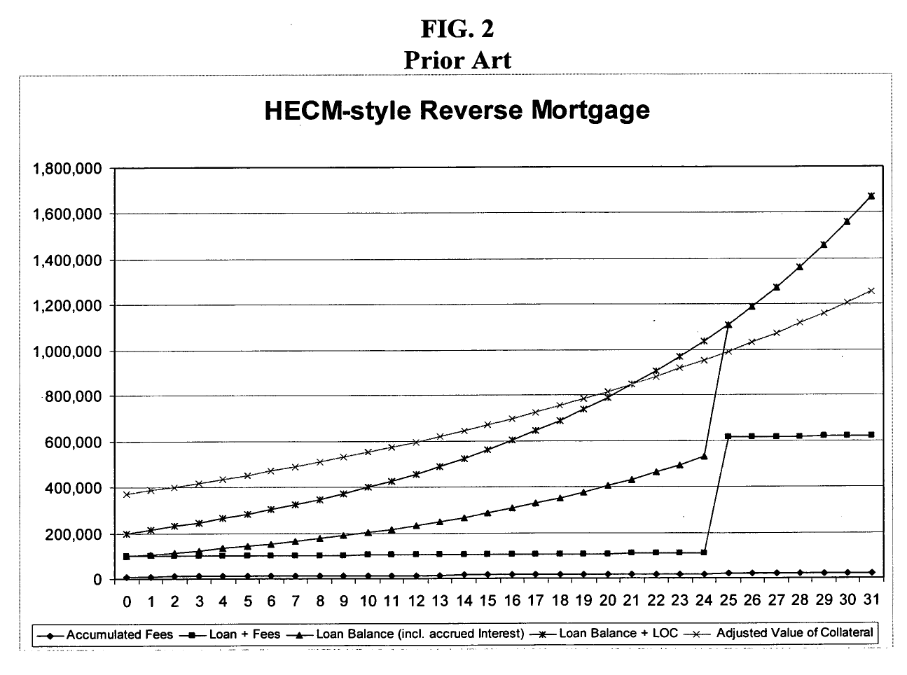

The initial value and the growth rate of the collateral (the property) is exactly the same as in the charts shown in FIGS. 1 and 2. The risk exposed in the FIG. 1 example becomes reality in the FIG. 2 example. However the FIG. 6 example does not expose the similar risk to the borrower.

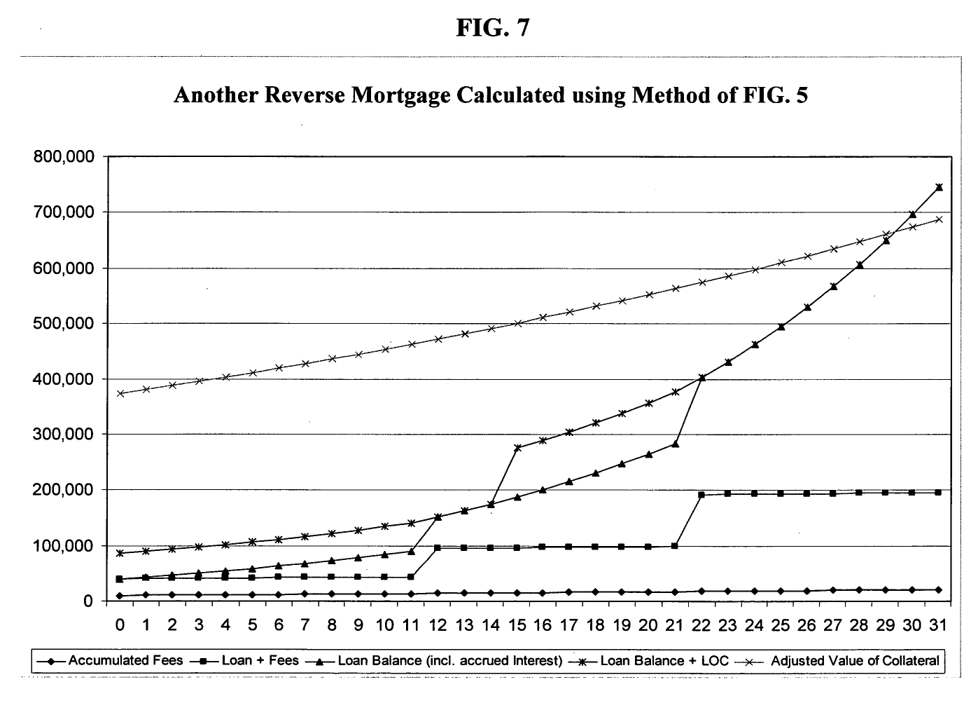

FIG. 7 is a chart illustrating another reverse mortgage calculated using the method of FIG. 5, according to even more exemplary embodiments. The chart of FIG. 7 is based on the same assumptions as FIG. 6, except that the property value only grows by 2%. That is, the property value growth is 2% (annual rate at what the value of the collateral grows). When FIG. 7 is compared to FIG. 6, there is no difference at closing. Also the line of credit remains the same after closing as long as it is not adjusted or no cash is drawn. However from there on the numbers change, the amounts available either for drawing or the new lines of credit in the respective years are lower.

In year 12, for example, the borrower draws all the line of credit, $50,874, which is $45,600*(1+0.01)̂11. All the values are exactly the same as in the FIG. 6 example.

In year 15, the age of the borrower is now 80, resulting in a life expectancy of 10 years (Table 1), which gives a principal limit factor of 0.51 (Table 2). This multiplied with the property value which is $538,347 in this year based on the above assumptions and run through the rest of the line of credit adjustment method, block (130) and forward, results in a line of credit of $87,830—significantly less than in the FIG. 6 example.

In year 22, the borrower draws all the line of credit. The line of credit has grown from the year 15 to the year 21, six years to $93,233=$87,830*(1+0.01)̂6.

In year 25, the age of the borrower is now 90, resulting in a life expectancy of 5.5 years (Table 1) (rounded 6 years), which gives a principal limit factor of 0.624 (Table 2). This multiplied with the property value which is now $656,242 and run through the rest of the line of credit adjustment method, block (130) and forward, results in a line of credit of $0. Thus there is no additional line of credit available.

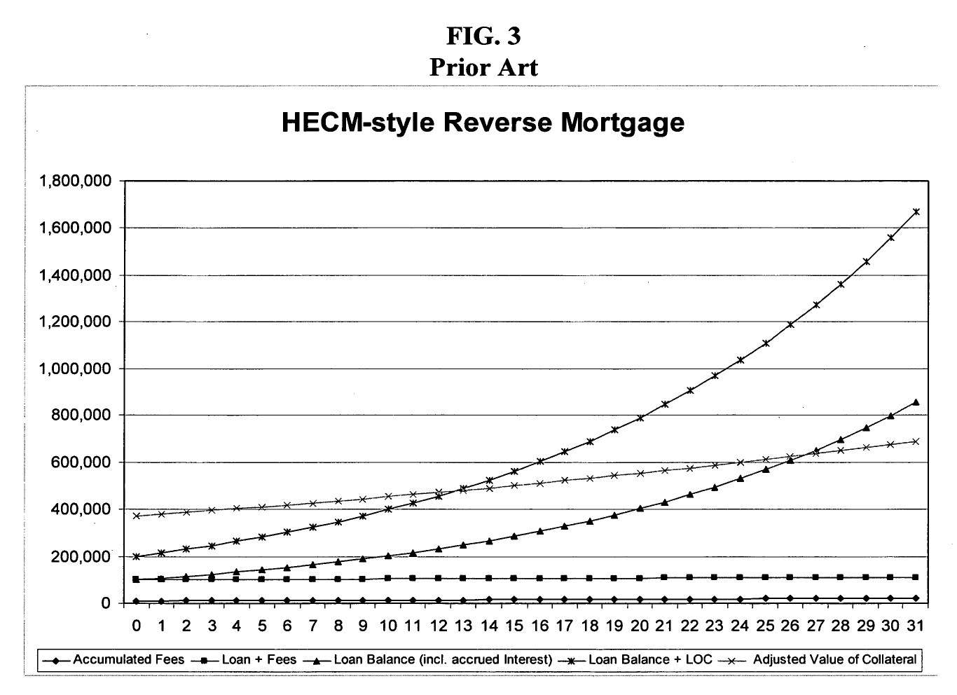

The example of FIG. 7 assumes the same growth rate for the property as in the example of FIG. 3. But unlike in the FIG. 3 example where the lender suffered a write-off of $600,000 to almost $1,000,000 in the year 31, the write-off for the lender in the FIG. 7 example in the year 31 is only $58,092. This is because the lender is much more restrictive with the line of credit; the borrower has access to less money.

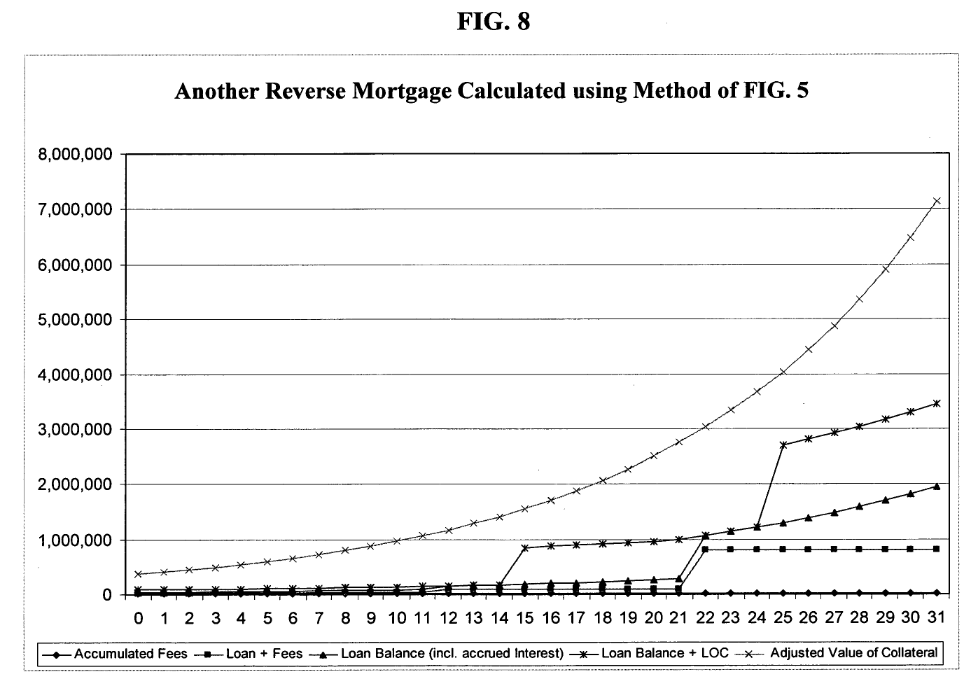

FIG. 8 is a chart illustrating still another reverse mortgage calculated using the method of FIG. 5, according to more exemplary embodiments. The chart of FIG. 8 is based on the same assumptions as FIG. 6, except that the property value now grows at 10% annual rate. When FIG. 8 is compared to FIG. 6, again there is no difference at closing. Also the line of credit remains the same after closing as long as it is not adjusted or no cash is drawn. However from there on the numbers change, the amounts available either for drawing or the new lines of credit in the respective years are higher.

In year 12, the borrower draws all the line of credit, $50,874, which is $45,600*(1+0.01)̂11. All the values are exactly the same as in the FIG. 6 example.

In year 15, the age of the borrower is now 80, resulting in a life expectancy of 10 years (Table 1), which gives a principal limit factor of 0.51 (Table 2). This multiplied with the property value which is $1,670,899 in this year based on the above assumptions and run through the rest of the line of credit adjustment method, block (130) and forward, results in a line of credit of $665,432—significantly more than in the FIG. 6 example.

In year 22, the borrower draws all the line of credit. The line of credit has grown from the year 15 to the year 21, six years to $706,369=$665,432*(1+0.01)̂6.

In year 25, the age of the borrower is now 90, resulting in a life expectancy of 5.5 years (Table 1) (rounded 6 years), which gives a principal limit factor of 0.624 (Table 2). This multiplied with the property value which is now $4,333,882 and run through the rest of the line of credit adjustment method, block (130) and forward, results in a line of credit of $1,405,794.

While the line of credit starts lower in the FIG. 8 example compared to the FIG. 1 example, it ends up much higher in the year 31, without carrying the risk for the lender to overshoot the adjusted value of the collateral. By using the proposed method in the FIG. 6 through FIG. 8 examples, the line of credit and thus the maximum loan balance is much more in line with the (adjusted) value of the collateral than in the conventional FIGS. 1-3 examples.

As mentioned earlier, exemplary embodiments may be implemented in processor-controlled devices. Because the architecture and operating principles of computers, communications devices, and other processor-controlled devices are well known, however, to those of ordinary skill in the art, these processor-controlled devices are not shown and described. If, however, the reader desires more details, the reader is invited to consult the following sources, all incorporated herein by reference in their entirety: WILLIAM STALLINGS, COMPUTER ORGANIZATION AND ARCHITECTURE: DESIGNING FOR PERFORMANCE (7th Ed., 2005); and DAVID A. PATTERSON & JOHN L. HENNESSY, COMPUTER ORGANIZATION AND DESIGN: THE HARDWARE/SOFTWARE INTERFACE (3rd. Edition 2004). Any such implementation in processor-controlled devices does not need to be implemented on one single location or one single processor. Distributed computing and service oriented architecture enables different blocks or sub-blocks to be executed at any location.

Exemplary embodiments may be applied regardless of networking environment. The communications network 22 illustrated in FIG. 4 may be a cable network operating in the radio-frequency domain and/or the Internet Protocol (IP) domain. The communications network 22, however, may also include a distributed computing network, such as the Internet (sometimes alternatively known as the “World Wide Web”), an intranet, a local-area network (LAN), and/or a wide-area network (WAN). The communications network 22 may include coaxial cables, copper wires, fiber optic lines, and/or hybrid-coaxial lines. The communications network 22 may even include wireless portions utilizing any portion of the electromagnetic spectrum and any signaling standard (such as the I.E.E.E. 802 family of standards, GSM/CDMA/TDMA or any cellular standard, and/or the ISM band, and/or satellite networks). The concepts described herein may be applied to any wireless/wireline communications network, regardless of physical componentry, physical configuration, or communications standard(s). Exemplary embodiments are also applicable to any television system and/or delivery mechanism. Exemplary embodiments may be applied to analog television, digital television, standard and/or high definition television, cable television network systems, and Internet Protocol television network systems.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

What is claimed is:

1. A method for adjusting a loan, comprising:
securing the loan with collateral;
establishing at least one of i) a line of credit and ii) a schedule of future payments; and
after closing of the loan, adjusting the line of credit and the schedule of future payments based on a value of the collateral and a balance of the loan.

2. The method according to claim 1, further comprising accessing an actuarial calculation based on at least one of i) a life expectancy of a borrower, ii) how long a borrower will live, and iii) how long the borrower will occupy the collateral.

3. The method according to claim 1, further comprising obtaining the value of the collateral.

4. The method according to claim 1, further comprising at least one of i) adjusting for set-asides and ii) adjusting for fees.

5. The method according to claim 1, further comprising receiving the balance of the loan and adjusting for interest.

6. The method according to claim 1, wherein adjusting the line of credit and the schedule of future payments is performed at least one of i) periodically and ii) at a lender's discretion.

7. The method according to claim 1, further comprising suggesting to perform the adjustment.

8. The method according to claim 1, further comprising evaluating a suggestion to make an adjustment and, based on a parameter, at least one of i) alerting a lender to make an offer and ii) making the offer to a borrower.

9. The method according to claim 1, further comprising calculating a new line of credit and comparing to an original line of credit.

10. The method according to claim 9, wherein when the new line of credit exceeds the original line of credit, then adjusting the line of credit available to the borrower.

11. The method according to claim 1, further comprising automatically paying at least a portion of the line of credit to a borrower.

12. A system for adjusting a loan, the system operative to:
secure the loan with collateral;
establish at least one of i) a line of credit and ii) a schedule of future payments; and
after closing of the loan, adjust the line of credit and the schedule of future payments based on a value of the collateral and a balance of the loan.

13. The system according to claim 12, further operative to access an actuarial calculation based on a life expectancy of a borrower.

14. The system according to claim 12, further operative to access an actuarial calculation based on at least one of i) how long a borrower will live and ii) how long the borrower will occupy the collateral.

15. The system according to claim 12, further operative to obtain the value of the collateral.

16. The system according to claim 12, further operative to receive the balance of the loan and adjust for interest.

17. The system according to claim 12, further operative to perform the adjustment at least one of i) periodically and ii) at a lender's discretion.

18. The system according to claim 12, further operative to suggest to perform the adjustment.

19. The system according to claim 12, further operative to evaluate a suggestion to make an adjustment and, based on a parameter, at least one of i) alert a lender to make an offer and ii) make the offer to a borrower.

20. A computer program product storing processor executable instructions for:
securing a loan with collateral;
establishing at least one of i) a line of credit and ii) a schedule of future payments; and
after closing of the loan, adjusting the line of credit and the schedule of future payments based on a value of the collateral and a balance of the loan.
